(19) United States
(12) Patent Application Publication
(10) Pub. No.: US 2024/0348562 A1
(43) Pub. Date: Oct. 17, 2024

(54) MULTI-HOST ISOLATION IN A SHARED NETWORKING PIPELINE

(71) Applicant: Intel Corporation, Sant Clara, CA (US)

(72) Inventors: Yotam Nizri, Mevaseret Tzion (IL); Wing Cheung, Fremont, CA (US); Thang Quang Nguyen, Austin, TX (US); Kenneth Keels, Austin, TX (US); Noam Elati, Zichron Yaakov (IL)

(73) Assignee: Intel Corporation, Santa Clara, CA (US)

(21) Appl. No.: 18/757,825

(22) Filed: Jun. 28, 2024

(51) Int. Cl. H04L 49/00; H04L 49/9005

(52) U.S. Cl. CPC H04L 49/3063; H04L 49/9005; H04L 49/70

(57) ABSTRACT

A shared networking pipeline is implemented by a network interface device and shared by a plurality of host devices. A pool of shared buffers of a network interface device correspond to one or more stages in the pipeline and are configured to allocate entries to the plurality of host devices based on the respective shares of the shared packet processing pipeline. Data is buffered associated with traffic of a first one of the plurality of host devices in a first subset of shared buffers, where the traffic is to proceed from a first stage to a second stage in the shared packet processing pipeline, and the data is associated with processing of the traffic by the second stage. Forward progress of the traffic is to be prevented from the first stage to the second stage when the first subset of entries are occupied.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

Some platforms make use of I/O virtualization in order to improve datacenter performance. Single Root I/O Virtualization (SR-IOV) and Sharing specification, version 1.0 (2007) by the Peripheral Component Interconnect (PCI) Special Interest Group (PCI-SIG), provided hardware-assisted high performance I/O virtualization and sharing of PCI Express devices. Intel® Scalable IOV (SIOV) and Application Defined Infrastructure (ADI) are additional input/output (I/O) virtualization specifications that may serve to markedly expands current Peripheral Component Interconnect Express (PCIe) device number limitations to increase a number of containers or services that can utilize a PCIe device.

### BRIEF DESCRIPTION OF THE DRAWINGS

FIG. 1 illustrates a block diagram of components of a datacenter in accordance with certain embodiments.

FIG. 2 is a simplified block diagram of an example system implementing I/O virtualization.

FIG. 3 is a simplified block diagram illustrating an example computing system.

FIG. 4 is a simplified block diagram illustrating an example network interface device coupled to multiple host devices.

FIG. 5 is a diagram illustrating an example arbitration algorithm for use by an example network interface device in a shared processing pipeline.

FIG. 6 is a simplified block diagram illustrating an processing pipeline and shared buffer pool in an example network interface device.

FIG. 7 is a flow diagram illustrating an example technique for preventing inefficient resource allocation among multiple hosts sharing resources of a network interface device.

FIG. 8 illustrates a block diagram of an example processor device in accordance with certain embodiments.

Like reference numbers and designations in the various drawings indicate like elements.

### DETAILED DESCRIPTION

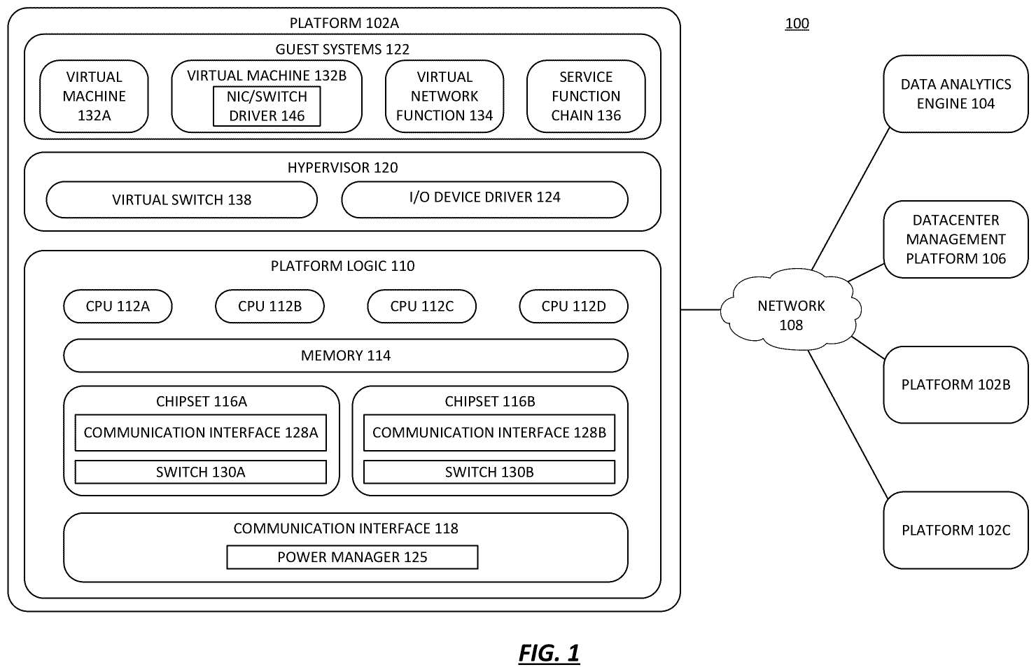

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. Various networking devices may be provided within the datacenter to provide resources facilitating communication for applications or services executed using the platform 102. In some cases, the hardware resources (e.g., physical functions) of these networking devices may be shared through virtualization or other techniques. Such systems may be enhanced, such as discussed below, to achieve host isolation in the sharing, between hosts, of these resources prevent head of line blocking to other hosts, among other example features.

A platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removeably coupled to platform 102. Although four CPUs are shown, a platform 102 may include any suitable number of CPUs. In some implementations, application to be executed using the CPU (or other processors) may include physical layer management applications, which may enable customized software-based configuration of the physical layer of one or more interconnect used to couple the CPU (or related processor devices) to one or more other devices in a data center system.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. A chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on the respective CPUs.

Chipsets 116 may include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, NVLink, and others, which may alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. A platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform. Further implementations may be supported, such as set forth above, for enhanced I/O virtualization. A host operating system may identify conditions and configurations of a system and determine that features (e.g., SIOV-based virtualization of SR-IOV-based devices) may be enabled or disabled and may utilize corresponding application programming interfaces (APIs) to send and receive information pertaining to such enabling or disabling, among other example features.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports). In some implementations, I/O virtualization may be supported within the system and utilize the techniques described in more detail below. I/O devices may support I/O virtualization based on SR-IOV, SIOV, among other example techniques and technologies.

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

Single Root I/O Virtualization (SR-IOV) is a PCI-SIG defined specification for hardware-assisted I/O virtualization that defines a standard way for partitioning endpoint devices for direct sharing across multiple VMs or containers. An SR-IOV capable endpoint device provides a Physical Function (PF) and multiple Virtual Functions (VFs). The PF of a device in SR-IOV provides resource management for the device and is managed by a host driver running in the host operating system (OS). A provided VF can be assigned to a VM or container for direct access. SR-IOV-capable devices may provide high performance I/O, including I/O devices such as network and storage controller devices as well as programmable or reconfigurable devices such as GPUs, FPGAs, and other accelerators, among other examples.

Scalable IOV (SIOV) also seeks to define an approach for the virtualization of I/O, for instance, within a data center. SIOV provides hardware-assisted I/O virtualization that enables a higher degree of scalability and performance in the sharing of I/O devices across isolated domains (e.g., VMs and containers). In SIOV, flexible composition of virtual devices for device sharing is enabled. Accesses between a VM and a virtual device are defined in SIOV as either a “direct path” access or an “intercepted path” access. Direct-path operations on the virtual device are mapped directly to the underlying device hardware for performance, while intercepted-path operations are emulated at least partially in software by a Virtual Device Composition Module (VDCM) to enable this greater flexibility in I/O virtualization. Which operations and accesses are processed as intercepted path versus direct path may vary depending on the device implementation and application. For instance, slow-path operations (e.g., initialization, control, configuration, management, QoS, error processing, and reset) are treated as intercepted-path accesses and fast-path operations (e.g., work submission and work completion processing) are treated as direct-path accesses, among other examples.

Similar to SR-IOV, resources of a given physical device may be mapped to individual VMs. In SIOV, a more customizable and granular approach is adopted, with SIOV enabling the flexible definition of virtual devices (VDEV) that may be mapped to a respective VM. High performance I/O devices may include a large number of command/completion interfaces for efficient multiplexing/demultiplexing of I/O. SIOV platforms may enable the assignment of such interfaces to isolated domains at a fine granularity. An SIOV architecture defines the granularity of sharing of a device or device resource as an “Assignable Device Interface” (ADI). Each ADI instance on the device may encompass the set of resources on the device that are allocated by software to support the direct-path operations for a virtual device. For instance, resources on a device associated with work submission, execution, and completion operations may implement device backend resources (e.g., command/status registers, on-device queues, references to in-memory queues, local memory on the device, or any other device-specific internal constructs). An ADI may identify a set (e.g., all or a subset of the total device resources, or even a combination of resources of two or more discrete devices) of device backend resources that are allocated, configured, and organized as an isolated unit, forming the unit of device sharing. The type and number of backend resources grouped to compose an ADI may be device specific. Each SIOV ADI on a device function may use the same PCIe Requester ID (Bus/Device/Function (BDF) number) corresponding to the device's PCIe Function. Process Address Space Identifiers (PASID) may be used to distinguish upstream memory transactions performed for different ADIs and to convey the address space targeted by the transaction.

ADIs form the unit of assignment and isolation for devices and are composed by software to form virtual devices (VDEVs). A Virtual Device Composition Module (VDCM) is responsible for managing virtual device instances. For instance, for direct-path accesses, a VMM may map the direct-path accesses from the guest directly onto the provisioned ADIs for the VDEV. For intercepted-path accesses, the VMM identifies the intercepted-path accesses from the guest and forwards them to VDCM for emulation. VDCM emulates the intercepted accesses to the VDEV. In some cases, the VDCM may access the underlying physical device corresponding to the ADI (e.g., to read a corresponding device register, identify ADI status, configure the ADI's PASID, etc.). Virtual device composition, among other advantages, enables increased sharing scalability and flexibility at lower hardware cost and complexity. SIOV utilizes software to define and share device resources with different address domains using different VDEV abstractions. For example, application processes may access a device using system calls and VMs may access a device using virtual device interfaces. Virtual device composition can also enable dynamic mapping of VDEVs to device resources, allowing a VMM to over-provision device resources to VMs. For instance, the resources of one or multiple physical devices may be mapped to a given VDEV. VDEVs may thus be defined to achieve particular goals of the system. As an example, in a data center with various physical machines containing different generations (e.g., versions) of the same I/O device, VDEVs may be defined to present the same VDEV capabilities irrespective of the different generations of physical I/O devices used in the VDEV definitions. Such a solution may allow the same guest OS image with a particular VDEV driver to be deployed or migrated to various combinations or deployments of physical machines.

During operation, upstream memory requests from all ADIs (within respective VDEV mapped to various VMs or containers) may be tagged with the Requester ID of the device (or device function) hosting the ADIs. Requests from different ADIs of the device function may be distinguished using a Process Address Space Identifier (PASID). The Requester ID and/or the PASID may be used to identify (e.g., in a TLP prefix) the address space associated with the request. Accordingly, when assigning an ADI to an address domain (e.g., VM, container, or process), the ADI may be configured with a unique PASID of the address domain and its memory requests may be tagged with the PASID value (e.g., in a PASID TLP Prefix).

As introduced above, in SIOV, a VDEV may serve as the abstraction through which a shared physical device is exposed to guest software. In some implementations, a VDEV may be exposed to a guest OS as a virtual PCI Express device. A VDEV may be defined to possess virtual resources such as virtual Requester ID, virtual configuration space registers, virtual memory BARs, virtual MSI-X table, etc. Each VDEV may be mapped to or formed from one or more ADIs (corresponding to various devices or device functions). The ADIs backing a VDEV may belong to the same physical function or allocated across multiple functions (e.g., to support device fault tolerance or load balancing).

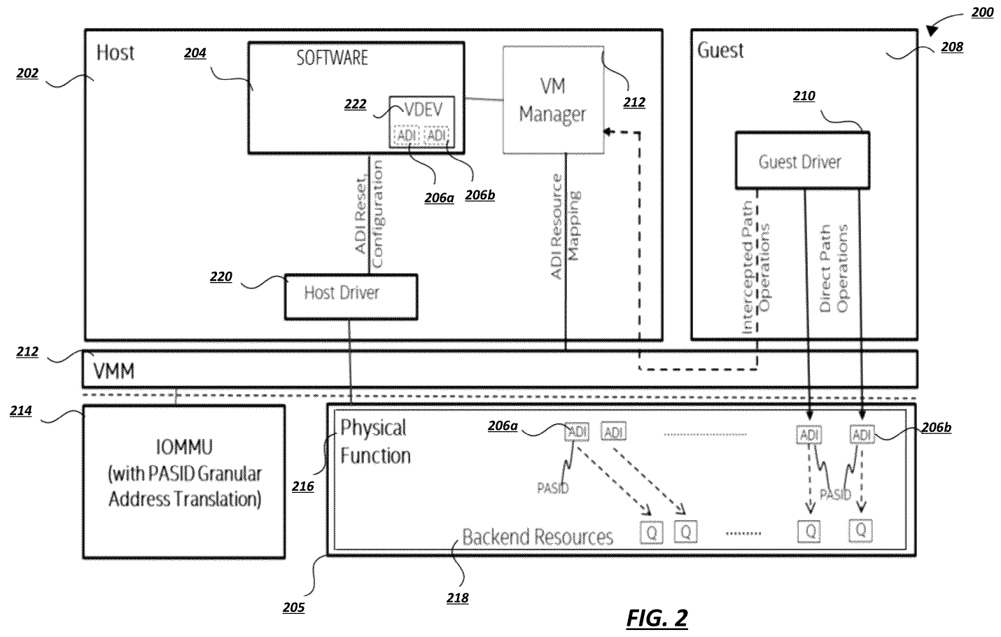

FIG. 2 is a simplified block diagram 200 illustrating a traditional implementation of an example operating environment 200 that supports the SIOV architecture to virtualize one or more devices (e.g., 205) such as component devices on a given computing system or other packages, such as accelerators, I/O devices, network processing devices, etc. In this example, the operating environment may include a host OS 202, a guest OS 208, a VMM 212, an input/output memory management unit (IOMMU) 214, and one or more devices (e.g., 205) possessing I/O resources capable of being virtualized (e.g., based on SR-IOV or SIOV, etc.). Host OS 202, guest OS 208, and/or VMM 212 may execute on the host hardware 104. Host OS 202 may include a host driver 220 and guest OS 208 may include a guest driver 210.

As shown, in conventional embodiments of SIOV environments, host OS 202 may include software 204 which may compose a virtual device (VDEV) 222 for the guest OS 208. In some embodiments, VDEV 222 may include virtual capability registers configured to expose device (or “device-specific”) capabilities to one or more components of operating environment 200. In various embodiments, virtual capability registers may be accessed by guest driver 210 of the device 205 to determine device capabilities associated with VDEV 222. The VDEV 222 may include one or more assignable device interfaces (ADIs) (also referred to as “assignable interfaces”), including an ADI 206a and an ADI 206b. In some embodiments, an ADI may be assigned, for instance, by mapping the ADIs 206a-206b into a MMIO space of the VDEV 222. An ADI generally refers to the set of backend resources 218 of the device 205 that are allocated, configured, and organized as an isolated unit, forming the unit of device sharing of the device 205. The type and number of backend resources 218 grouped to compose a given ADI 206a, 206b, may be specific to the device 205. An ADI 206a, 206b may be associated with a device context, rather than with specific device resources. As another example, the backend resources 218 of the ADIs 206a-206b may include one or more shared work queues. A repository (not pictured) or other data structure may store a plurality of different ADIs and the respective attributes of each ADI.

For example, if the device 205 is a network controller, the ADIs 206a-206b may provide backend resources 218 that include transmit queues and receive queues associated with a virtual switch interface. As another example, if the device 205 is a storage device, the ADIs 206a-206b may provide backend resources 218 that include command queues and completion queues associated with a storage namespace. As yet another example, if the device 205 is a graphics processing unit (GPU), the ADIs 206a-206b may provide backend resources 218 that include dynamically created graphics or compute contexts, among other example devices and ADIs.

The IOMMU 214 may be configured to perform memory management operations, including address translations between virtual memory spaces and physical memory. As shown, the IOMMU 214 may support translations at the Process Address Space ID (PASID) level. Generally, a PASID may be assigned to each of a plurality of processes executing on the host hardware 104 (e.g., processes associated with guest OS 208 and/or VMs). Doing so enables sharing of the device 205 across multiple processes while providing each process a complete virtual address space.

In some implementations, software 204 may implement a VDCM. In some instances, a distinct instance of software 204 (or a VDCM) may be provided for each device which is to be virtualized. For instance, a VDCM may be implemented as a device-specific component responsible for composing and implementing VDEV instances 222 using one or more ADIs allocated, for instance, by a host driver 220. The VDCM implements software-based virtualization of intercepted-path operations and arranges for direct-path operations to be submitted directly to the backing ADIs. The host driver 220 may be loaded DCMs may be implemented and packaged by device vendors in a various ways, such as user-space modules or libraries that are installed as part of the host driver or a. In other implementations, the VDCM may be a kernel module. If implemented as a library, the VDCM may be statically or dynamically linked with the hypervisor-specific virtual machine resource manager responsible for creating and managing VM resources. If implemented in the host kernel, the VDCM can be part of the host driver. The host driver is loaded and executed as part of the host OS or hypervisor software. The host driver may report support for SIOV (and/or SR-IOV) to system software through the driver interface. In addition to traditional device driver functionality, the host driver 220 may implement software interfaces (e.g., as defined by the host OS or hypervisor infrastructure) to support enumeration, configuration, instantiation, and management of ADIs. The host driver may be responsible for configuring the ADIs, including aspects such as PASID identity, Interrupt Message Storage entries, MMIO register resources for direct-path access to the ADI, and any device-specific resources, among other example functionality and features. An SIOV compatible guest driver 210 may manage the VDEV instances composed by the VDCM. Direct-path accesses by the guest driver 210 may be issued directly to the ADIs (e.g., 206a-b) mapped to the VDEV, while intercepted-path accesses are intercepted and virtualized by the VDCM (e.g., 204). In some implementations, guest and host drivers can be implemented as a unified driver that supports both host and guest functionality or as two separate drivers. For existing SR-IOV devices, if the VDEV can be composed to behave like an existing VF, the Intel Scalable IOV guest driver can be same as the SR-IOV VF driver, among other examples.

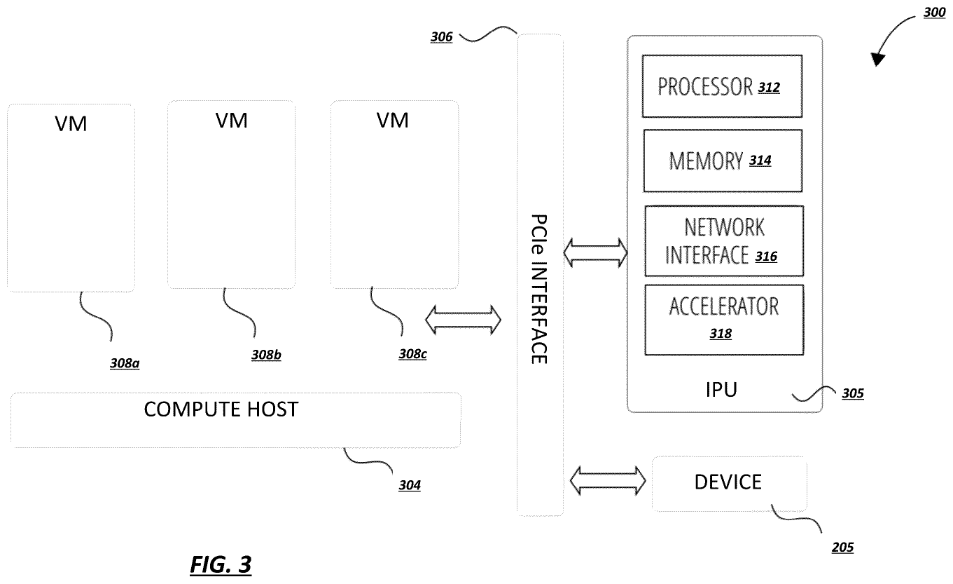

Turning to FIG. 3, a simplified block diagram 300 is shown illustrating an example network interface device 305, such as an infrastructure processing unit (IPU), smart network interface controller (smart NIC), or other networking device posing networking interfaces, networking circuitry, memory, and microcontroller (e.g., CPU). In this example, a network interface device 305 is coupled to host hardware 304, and a device 205 coupled via a PCIe interface 306. The network interface device 305, host hardware 104, device 205, and PCIe interface 306 may be implemented in circuitry. For example, the network interface device 305, host hardware 304, device 205, and PCIE interface 306 may be communicably coupled components of a compute node, server blade, server rack, or any other computing hardware. The host hardware 304 includes at least one processor circuit and memory (each not pictured). network interface device 305 also includes at least one processor 312, memory 314, an accelerator 318, and a network interface device 316 (e.g., a wired and/or wireless Ethernet network interface). The network interface device 316 may provide an interface to other devices via a network (e.g., a local area network (LAN), a wide area network (WAN), the Internet, etc.) and may support the Institute of Electrical and Electronics Engineers (IEEE) suite of Ethernet standards (e.g., 802.1, 802.3, etc.). The device 205 may be any type of peripheral device, such as a PCIe-compatible device. Although the PCIe interface 306 is used as a reference example of an interface, other interfaces may be used in the operating environment. For example, a Compute Express Link® (CXL) interface, a peripheral component interconnect (PCI), interface, a universal serial bus (USB) interface, a serial peripheral interconnect (SPI), an integrated interconnect (I2C), or a Universal Chiplet Interconnect Express (UCIe) interface may be used instead of the PCIe interface 306, among other examples. Therefore the device 205 may be a USB device, PCI device, PCIe device, CXL device, UCIe device, I2C, and/or an SPI device and provide I/O resources (e.g., for virtualization) in accordance with its corresponding I/O protocol or technology. The network interface device 305 further includes a direct memory access (DMA) engine to facilitate DMA transactions, among other example features.

The host hardware 304 may be representative of one or more processors and memory to execute one or more virtual machines (VMs), such as VM 308a, VM 308b, and VM 308c (or other containers or other isolated domains). The network interface device 305 includes one or more programmable or fixed function processors to perform offload of operations that could have been performed by processors of the host hardware 304. The network interface device 305 may therefore be considered as an “offload device.” More generally, the network interface device 305 may perform virtual switch operations, manage storage transactions (e.g., compression, cryptography, virtualization), and manage operations performed on other IPUs, smart NICs, compute nodes, servers, and/or devices.

In some computing environments, network interface devices may be included with networking resources and functionality, which may functionally be shared to implement a shared pipe where more than one host is sharing one pipe. Within such a pipe, or pipeline, a number of functions and transactions may occur, such as retrieving descriptors, reading data, etc., which involve reads and/or writes from individual hosts' memory. In a shared pipeline, when one host is slow, the overall pipeline becomes congested and will lead to head of the line blocking of the other hosts (which may not be operating as slow (e.g., based on better performing memory access latency than the blocking host). As an example, functional modules in remote direct memory access (RDMA) networking provided through network interface devices are designed to service multiple hosts. When memory access latencies are not the same for all hosts, the slow host can block other fast hosts. Additionally, in RDMA, there is traffic from multiple clients or tiles accessing multiple PCIe hosts. These hosts are to function as independent entities and, therefore, there is an expectation that independent client requests will be guarded from starvation due to a lack of resources within the shared network interface device. For instance, in a compute block with multiple clients accessing a common buffer pool, the unfairness of buffer allocation can result when the buffer pool runs out of space and more requests are coming in.

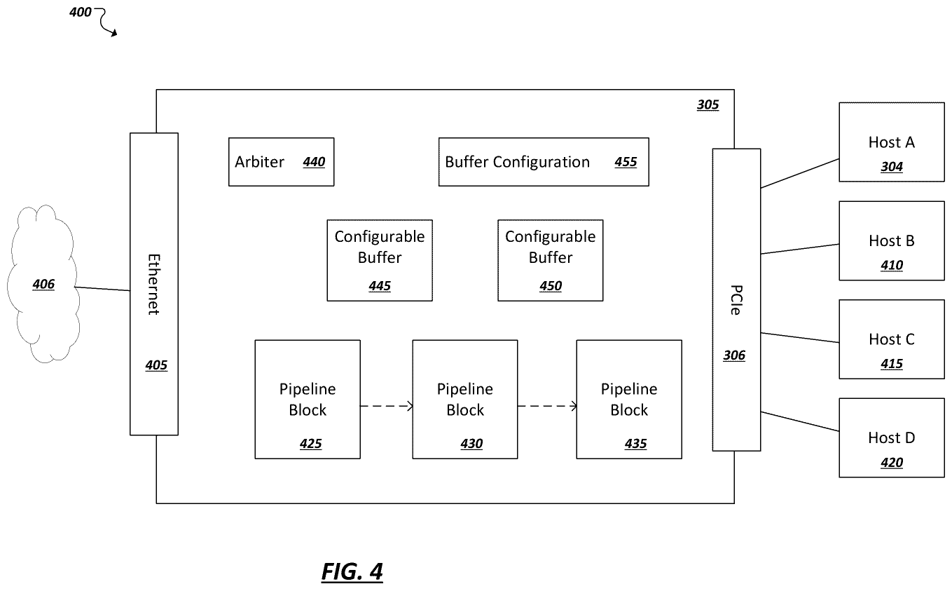

In an improved implementation, a network interface device may be configured to implement buffers, which are configured to attempt to ensure that each active host (or client) will have a fair share of the buffer pool. This may be leveraged to achieve higher buffer utilization with relatively minimal buffer area. For instance, FIG. 4 is a simplified block diagram 400 showing an example network interface device 305, such as a smart NIC or IPU (among other possible example implementations). In this example, the network interface device 305 may include a first port or interface (e.g., 405), such as an Ethernet port, to couple to a network 406 (e.g., a local area network, the Internet, or another example network). The network interface device 305 may facilitate connections with the network 406 for various host devices (e.g., 304, 410, 415, 420, etc.). The host devices may couple to the network interface device 305 to gain access to the functionality provided by the network interface device 305 via one or more second interfaces (e.g., 306) (e.g., a PCIe, CXL, or other port). The network interface device 305 may be provided various logic blocks (e.g., implemented in hardware circuitry and/or firmware) to implement various packet processing pipelines to facilitate the communication of the packets to/from the network 406 from/to the various host devices (e.g., 304, 410, 415, 420), among other examples. In the simplified example shown in FIG. 4, the network interface device 305 includes pipeline blocks (e.g., 425, 430, 435) to implement respective packet processing stages within a packet processing pipeline implemented using the network interface device 305. For instance, an example pipeline may include a first action, set of actions, or stage performed using logic of pipeline block 425, followed by the performance of another stage performed using logic of pipeline block 430, and thereafter followed by the performance of a third stage using logic of pipeline block 435.

Resources (e.g., hardware resources, interconnect resources, compute resources, etc.) provided by a given pipeline block 425 (e.g., implemented as an intellectual property (IP) or circuitry block) may be shared between multiple host devices (e.g., 304, 410, 415, 420) connected to the network interface device 305 via interface(s) 306. For instance, various virtualization techniques and protocols may be utilized to allow multiple hosts (and the respective services or applications executed using the respective host) to share (e.g., in a multiplexed manner) the same pipeline block within a same period of time. An arbiter block 440 may be utilized to multiplex requests/completions arriving from various hosts at the processing pipeline. In some implementations, one or more configurable buffers (e.g., 445, 450) may be implemented (e.g., using memory resources of the network interface device 305). The configurable buffers 445, 450 may be utilized to facilitate isolation between the hosts' use of a given pipeline block and prevent one of the hosts from blocking other hosts' effective use of the pipeline block. The buffers (e.g., 445, 450) may be configurable (e.g., during boot time) to account for respective service levels assigned to respective hosts in the set of hosts (e.g., 304, 415, 420, 425) coupled to the network interface device 305 (and in active operation). Buffer configuration logic (e.g., 455) may be provided to facilitate the configuration of the buffers (e.g., 445, 450), for instance, at the direction of a controller, system software, etc. communicating with the buffer configuration logic 455 via an interface (e.g., an application programming interface (API)).

Continuing with the example of FIG. 4, respective stages implemented by respective resources (e.g., a respective pipeline block (e.g., 425, 430, 435, etc.) may have limited resources that share an interface between stages (e.g., an interface between pipeline block 425 and 430, an interface between pipeline block 430 and 435, etc.). The manner in which these limited resources of a stage are shared may be carried out flexibly based on service level agreements, bandwidth guarantees, orchestration policies, etc. on a per host basis. In some implementations, a credit based flow control may be utilized based on resources assigned to the respective hosts per stage and in accordance with the service level agreement or rates expected per host. Buffers (e.g., 445. 450) may be provided and respective portions of respective buffers (e.g., 445, 450) partitioned and assigned to corresponding hosts (e.g., 304, 410, 415, 420) to correspond to the respective share of the stage's (or stages') resources the host is assigned (e.g., during configuration). Using the buffers, host-specific traffic and latency may be monitored and traffic from hosts (e.g., whose buffers are full) may be throttled (e.g., using arbiter 440) when the entries of the corresponding host's buffer are filled (e.g., indicating that the host is processing transactions relatively slowly). In this manner, slow hosts will not affect the performance of other hosts or of a feature like RDMA implemented across multiple stages of a networking device (e.g., IPU, NIC, etc.). Accordingly, a multi-stage shared pipeline may be implemented using the network interface device to prevent blocking of other stages' host isolation across the system (e.g., an SOC). Subscription, Service Level Agreement (SLA), Service Level Obligation (SLO), quality of service, and bandwidth guarantees may be honored across the different hosts. Further, unused resources can be flexibly over-subscribed to achieve efficient resource utilization (e.g., buffer, bandwidth, FIFO depth, cache, scratchpad, etc.), among other examples.

As in the example of FIG. 4, multiple hosts (e.g., 304, 410, 415, 420) may be coupled to a network interface device (e.g., 305) and respective hosts may own one or multiple physical function numbers (pf_num). Host-based flow control may be enforced by the network interface device 305 such that a slow host does not block faster hosts in the set of hosts coupled to the network interface device. Resources (e.g., of respective pipeline blocks (e.g., 425, 430, 435)) are carved out for each of the enabled hosts, based on their subscription rate. For instance, a buffer-based reservation technique may be implemented at the network interface device (e.g., 305) through one or more pools of buffers (e.g., 445, 450). A buffer or buffer pool may be divided into N clients (associated with hosts (e.g. 304, 410, 415, 420) to guarantee bandwidth allocation. The number of buffers reserved for each host may be programmable. A host's (or client's) requests may be queued up into a first-in first-out buffer (FIFO). An arbiter (e.g., 440) may implement a traffic controller for requests from the various hosts using the configured buffer pool.

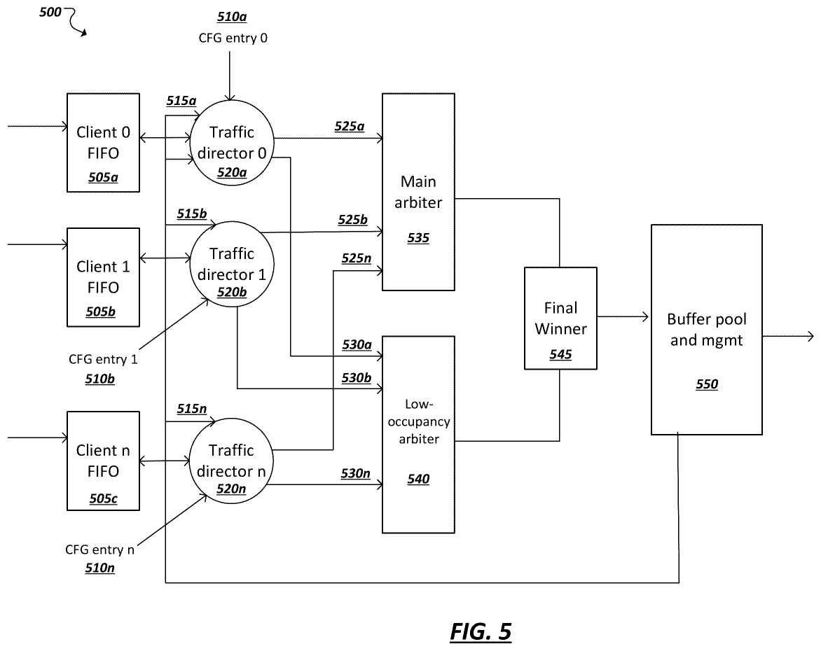

Turning to FIG. 5, a flow diagram 500 is shown illustrating an example technique for performing traffic control for shared resources of a network interface device between multiple hosts using a buffer pool, such as discussed herein. For instance, in one example implementation, arbiter logic of the network interface device may take, as inputs: a client request from the top of the FIFO (e.g., 505a-n), a programmed buffer value (e.g., 510a-n) indicating the allocated size of the respective host's buffer, and the current state (e.g., 515a-n) of the host's buffer (e.g., as provided through buffer pool management logic 550). From these inputs, arbitration logic (e.g., 520a-n) may generate two sets of requests (e.g., for each of the hosts). The first request (e.g., 525a-n) is activated when the number of outstanding buffer reservations belonging to the client is less than the programmed value. The second request (e.g., 530a-n) is activated when the number of outstanding buffer reservations belonging to the client is equal to or exceeds the programmed value. The first requests (e.g., 525a-n) of the hosts are routed to a main arbiter (e.g., 535) and the second requests (e.g., 530a-n) of the hosts are routed to a low-occupation arbiter (e.g., 540). The respective arbiters (e.g., 535 and 540) may determine a respective winner, and from these a final winner (e.g., 545) is derived (which corresponds to the next request which will be granted access to the shared networking resource(s)). In case both arbiters 535, 540 have a winner, the main arbiter's winner wins, and the winner of the low-occupancy arbiter is on hold. Otherwise, the winner from the appropriate arbiter is to be selected as the winner 545.

One example advantage of the technique shown and described in the example of FIG. 5, is that each respective host is assured its fair share of the buffer pool when available or when a buffer space becomes available based on the subscription rate determined for and assigned to the respective host. Further, in addition to ensuring fairness, this approach also does not limit an individual host client from claiming more buffers above its reservation value (e.g., 510a-n) when additional buffer space remains available, thus ensuring maximum buffer utilization, unlike traditional approaches using round-robin arbitration and a common pool of buffers which may result in starvation situations when the buffer pool is running out of space and more requests are coming in. For instance, as an example, if (e.g., during boot time) the division of shared resources (and the corresponding buffer pool) is configured to allocate 70% to a first host and 20% to a second host, 10% of the resources may remain unused, which may be flexibly and dynamically allocated to either the first or second host (e.g., based on their utilization, as measured through their respective buffers) to improve performance of both the first and second hosts, among other examples.

A shared buffer pool may function as a configurable database to enable multi-host isolation. An arbiter (e.g., 440) may be provided which is host aware (e.g., identifying traffic associated with individual hosts in the grouping of hosts connected to the network interface device) and is operable to halt traffic from the host. Pipeline host isolation may be achieved through shared buffers that correspond to interfaces or boundaries between stages in a network data processing pipeline and absorb data associated with hosts' request (e.g., including the requests themselves in some instances). These buffers may then serve as the basis for triggering the application of back pressure to the traffic of one or more of the specific hosts at a previous isolation stage in the pipeline. Buffers may be accompanied by corresponding arbitration logic (e.g., to trigger back pressuring of individual host traffic) to implement multi-host buffer units along the pipe. A buffer unit may act as a landing zone for the outstanding requests requested by the previous unit in the pipe and is configured to achieve desired host's bandwidth. The internal arbitration logic of a multi-host unit may manage credits with a prior stage to cause the prior stage to stop sending a given host's traffic when the host's configurable database, or buffer entries, is getting full. As the output for the buffer unit, arbitration logic may be used to select the next host's traffic to output with respect to the published credits or remaining subscription from the next unit in the pipe. In other words, if a host has no storage left in the buffer-implemented landing zone following a processing stage, the host will not be a candidate for the next arbitration and will not make forward progress along the shared pipeline until the landing zone has one or more vacancies. Bandwidth can be divided between the different hosts using multi-host static configuration that effectively grants a cut of the database or buffer pool to respective hosts according to the configuration (e.g., based on host-specific SLAs or other policies).

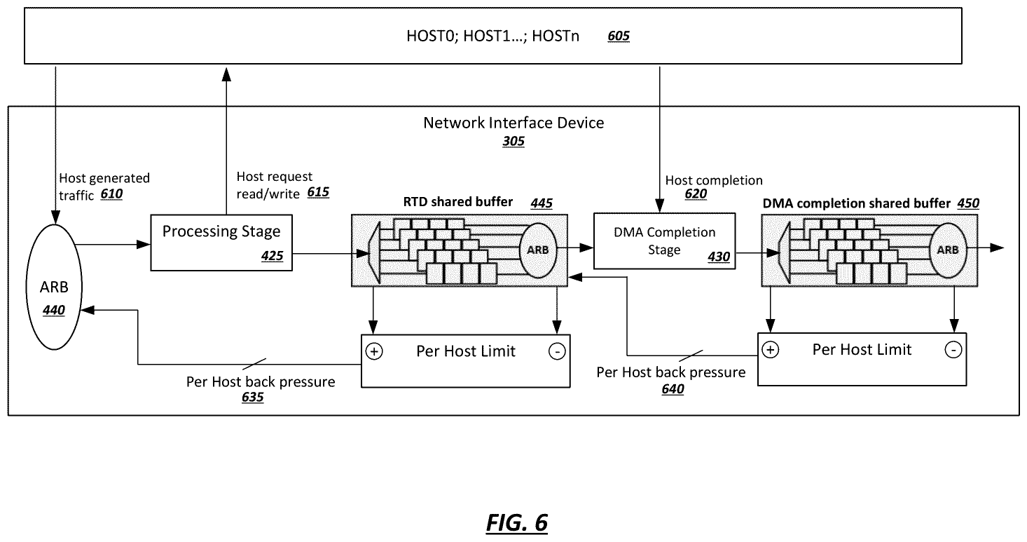

Turning to the simplified block diagram 600 of FIG. 6, an example implementation of an example network interface device 305 (e.g., an IPU, smartNIC, DPU, etc.) is shown coupled to a set of multiple host devices (e.g., 605) that are to make use shared use of hardware resources of the network interface device 305 (e.g., associated with data to be sent or received on a network coupled to the network interface device 305). In the example of FIG. 6, a portion of a packet processing pipeline is shown, including a processing stage 425 (implemented in corresponding hardware) followed by a second processing stage 430 (e.g., DMA completion stage). As such, if a host is slow (e.g., due to high internal memory latency) in completing tasks associated with its use of the first processing stage hardware 425, the potential arises for head of line blocking and for underutilization of the network interface device resources (e.g., 430) associated with the downstream stages of the processing pipeline.

Continuing with the example of FIG. 6, a shared pool of buffers may be maintained by the network interface device 305 and include respective buffers (e.g., 445, 450) for respective stages (e.g., 425, 430) in the processing pipeline. The network interface device 305 may configure the buffers based on the respective shares of pipeline and/or stage bandwidth that are to be applied to respective hosts 605 coupled to the network interface device 305 (e.g., based on respective SLAs). For instance, buffer 445 and buffer 450 may be configured to the system's active hosts (e.g., where inactive host's SLAs and bandwidth shares are ignored) and their desired, advertised, or guaranteed rates. For instance, out of three hosts, two may be active with equal shares of the network interface device resources. Accordingly, the two active hosts may be each assigned a respective 50% of the buffer pool (e.g., 50% of each of the entries in buffer 445 and 50% of buffer 450, etc.), among other examples. For instance, if the size of buffer 445 is 100 entries, 50 entries are assigned to the first active host and 50 entries are assigned to the second active host.

As illustrated in the example of FIG. 6, multi-host traffic 610 may arrive from the hosts 605 at one or more interfaces (e.g., a shared PCIe or CXL interface) of the network interface device 305 and arbitration logic (e.g., 440) may determine an initial ordering for requests from the hosts 605. The queuing of requests for processing stage 425 may be based on a corresponding buffer 445, such that per host back pressure is applied or fed-back to the arbitration logic 440 to throttle traffic of any slow hosts (e.g., whose entries in buffer 445 are filled). For instance, buffer management circuitry may be provided to monitor the buffers and cause backpressure to be applied for a given host's requests in preceding stages of the pipeline when the host's buffer allocation is filled (e.g., due to the host's relative slow performance).

In one example, an output of a processing stage (e.g., 425) may be a host Data Memory Access or Direct Memory Access (or DMA) read or write request 615. As such, associated metadata (e.g., information from the contents of the packet (e.g., from header fields or the payload itself), data descriptors that point to packet buffers in host memory, packet descriptors describing the packet and offloads (e.g., TCP Segmentation Offload (TSO), Receive Segment Coalescing (RSC), Checksum Offload, etc., packet state information), etc.) may be stored in a shared buffer 445 to compensate for the Round Trip Delay (RTD) latency associated with this request 615. At this stage, the empty slots in the buffer are guaranteed since the per host limit protected the pipeline from oversubscribing the buffer. The corresponding host may perform memory related tasks associated with the request 615 (e.g., retrieving a descriptor, writing data to a buffer, retrieving payload data for a packet to be sent out on the network, etc.) and send a corresponding DMA completion 620 back to the network interface device 305 for processing using DMA stage logic resources (e.g., 450). When the DMA completion 620 arrives back from the host, the data is stored in the DMA completion shared buffer 450 which serves as a DMA landing zone. At this stage, the empty slots in this buffer are guaranteed since the per host limit protected the pipeline from oversubscribing this buffer. If a host runs out of buffer allocation in connection with one or more of the stages of the pipeline, buffer management logic may throttle further requests from a corresponding host to avoid head of line blocking. For instance, arbitration logic (ARB) may be provided in association with one or more of the buffers (e.g., 445, 450) to receive feedback or throttling signals (e.g., 635, 640, etc.) from one or more of the upstream buffers to cause the arbitration logic associated with a corresponding processing stage to temporarily hold or block requests of the slow host from making forward progress until the corresponding buffers identify that buffer entries are free, a timer has elapsed, or some other condition is satisfied to allow back pressure applied to the host's traffic to be released. As such, a cascade of feedback (e.g., from buffer unit 450 to buffer unit 445 using backpressure signal 640 and buffer unit 445 to arbiter 440 using backpressure signal 635) allows downstream blocking events from a slow host to be fed back to potentially even the beginning of the pipeline (e.g., as controlled by arbiter 440) to apply stage-specific or even pipeline-long back-pressuring of traffic belonging to a slow host.

In some implementations, the principles and network interface device discussed above may be utilized to implement host isolation within the context of remote direct memory access (RDMA). Circuitry or other logic utilized to implement an RDMA engine may be shared and the corresponding resources may allocated per host-specific bandwidth requirements, SLAs, or other policies. Per-host flow control may be implemented between each module, including the RDMA engine. For instance, all traffic in and out of the RDMA engine may be assigned to a host identifier (host ID) (e.g., the RDMA engine implemented as a particular pipeline block in a network interface device and capable of being shared between a number of hosts and capable of supporting a number of static configurations). Host isolation may be implemented at the RDMA engine, such as discussed herein, to enforce no head of line blocking between hosts to ensure no starvation between the hosts. As such, resources in the RDMA engine are carved out for each enabled host in accordance with the performance standards (e.g., subscription rate) to attempt to continuously meet these performance standards on a per-host basis.

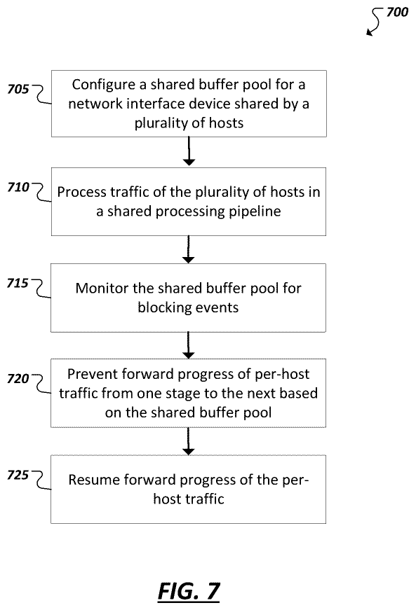

FIG. 7 is a simplified flow diagram 700 of an example technique for preventing inefficient resource allocation among multiple hosts sharing resources of a network interface device. For instance, a shared buffer pool (e.g., including one or more shared buffers corresponding to one or more stages in a shared processing pipeline implemented by hardware resources of the network interface device) may be configured 705 to allocate respective subsets of entries in the buffer pool to respective hosts according to the subscribed rates, service levels, or bandwidth guarantees dictating each host's respective share of the processing pipeline. Traffic (e.g., in the form of requests of the network interface device to process packets associated with various microservices, services, and applications executed by the respective hosts) is processed 710 using various blocks of hardware of the network interface device to advance processing of each host's traffic through a pipeline of processing stages implemented by the network interface device. Shared buffers in the shared buffer pool may correspond to respective stages in the pipeline or interfaces or transitions between consecutive processing stages. The buffer pool is monitored 715 at the network interface device to identify potential blocking events (e.g., head of line blocking) due, for instance, to a given host performing tasks associated with the processing pipeline (e.g., memory transactions involving retrieving information (e.g., descriptors, payloads, etc.) from local host memory for use by the network interface device in the pipeline)) at a slow rate relative to other hosts sharing the pipeline. Based on the monitoring 715 of the buffers, and based on detection of a potential blocking event, buffer management and/or arbitration logic of the network interface device may cause traffic of a slow host to be back pressured 720 such that traffic of the slow host is temporarily blocked from making forward progress from one stage in the pipeline to the next. Such blocking may be released 725 and progress allowed (e.g., albeit, in some cases, at a slower rate than before the blocking event) when the monitoring 715 of the shared buffers indicates that doing so will not cause faster hosts to be penalized, among other example features and implementations.

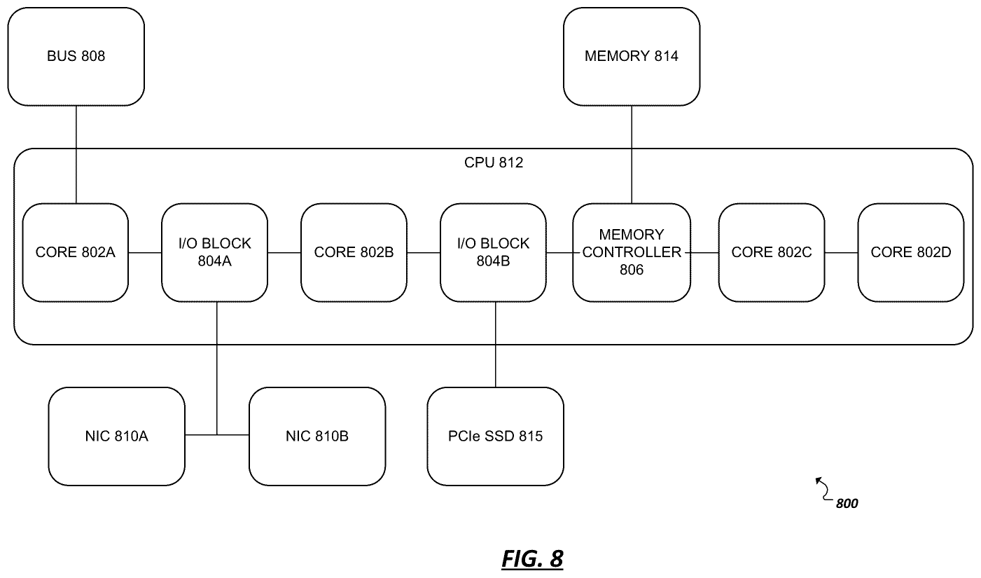

Note that the apparatus', methods', and systems described above may be implemented in any electronic device or system as aforementioned. As a specific illustration, FIG. 8 provides an exemplary implementation of a processing device such as one that may be included in a network interface device. It should be appreciated that other processor architectures may be provided to implement the functionality and processing of requests by an example network interface device, including the implementation of the example network interface device components and functionality discussed above. Further, while the examples discussed above focus on improvements to an Ethernet subsystem and links compliant with an Ethernet-based protocol, it should be appreciated that the principles discussed herein are protocol agnostic and may be applied to interconnects based on a variety of other technologies, such as PCIe, CXL, UCIe, CCIX, Infinity Fabric, among other examples.

Referring to FIG. 8, a block diagram 800 is shown of an example data processor device (e.g., a central processing unit (CPU)) 812 coupled to various other components of a system in accordance with certain embodiments. Although CPU 812 depicts a particular configuration, the cores and other components of CPU 812 may be arranged in any suitable manner. CPU 812 may comprise any processor or processing device, such as a microprocessor, an embedded processor, a digital signal processor (DSP), a network processor, an application processor, a co-processor, a system on a chip (SOC), or other device to execute code. CPU 812, in the depicted embodiment, includes four processing elements (cores 802 in the depicted embodiment), which may include asymmetric processing elements or symmetric processing elements. However, CPU 812 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 812, as illustrated in FIG. 8, includes four cores-cores 802A, 802B, 802C, and 802D, though a CPU may include any suitable number of cores. Here, cores 802 may be considered symmetric cores. In another embodiment, cores may include one or more out-of-order processor cores or one or more in-order processor cores. However, cores 802 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 802 may include a decode module coupled to a fetch unit to decode fetched elements. Fetch logic, in one embodiment, includes individual sequencers associated with thread slots of cores 802. Usually a core 802 is associated with a first ISA, which defines/specifies instructions executable on core 802. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 802 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 802, in one embodiment, recognize the same ISA (or a subset thereof). Alternatively, in a heterogeneous core environment, a decoder of one or more cores (e.g., core 802B) may recognize a second ISA (either a subset of the first ISA or a distinct ISA).

In various embodiments, cores 802 may also include one or more arithmetic logic units (ALUs), floating point units (FPUs), caches, instruction pipelines, interrupt handling hardware, registers, or other suitable hardware to facilitate the operations of the cores 802.

Bus 808 may represent any suitable interconnect coupled to CPU 812. In one example, bus 808 may couple CPU 812 to another CPU of platform logic (e.g., via UPI). I/O blocks 804 represents interfacing logic to couple I/O devices 810 and 815 to cores of CPU 812. In various embodiments, an I/O block 804 may include an I/O controller that is integrated onto the same package as cores 802 or may simply include interfacing logic to couple to an I/O controller that is located off-chip. As one example, I/O blocks 804 may include PCIe interfacing logic. Similarly, memory controller 806 represents interfacing logic to couple memory 814 to cores of CPU 812. In various embodiments, memory controller 806 is integrated onto the same package as cores 802. In alternative embodiments, a memory controller could be located off chip.

As various examples, in the embodiment depicted, core 802A may have a relatively high bandwidth and lower latency to devices coupled to bus 808 (e.g., other CPUs 812) and to NICs 810, but a relatively low bandwidth and higher latency to memory 814 or core 802D. Core 802B may have relatively high bandwidths and low latency to both NICs 810 and PCIe solid state drive (SSD) 815 and moderate bandwidths and latencies to devices coupled to bus 808 and core 802D. Core 802C would have relatively high bandwidths and low latencies to memory 814 and core 802D. Finally, core 802D would have a relatively high bandwidth and low latency to core 802C, but relatively low bandwidths and high latencies to NICs 810, core 802A, and devices coupled to bus 808.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: an interface to couple to a plurality of hosts; first circuitry to perform an action in a first packet processing stage of a processing pipeline; second circuitry to perform an action in a second packet processing stage of the processing pipeline, where the second packet processing stage is to follow the first packet processing stage, and the plurality of hosts are to share the first circuitry and the second circuitry; buffer management circuitry to configure a shared buffer, where the shared buffer is to be shared between the plurality of hosts to assign a first number of buffer entries in the shared buffer to hold data associated with a first one of the plurality of hosts and the second packet processing stage and a second number of buffer entries to hold data associated with a second one of the plurality of hosts and the second packet processing stage; and an arbiter to select traffic of one of the first one of the plurality of hosts or the second one of the plurality of hosts to be processed in the second packet processing stage based on the request buffer.

Example 2 includes the subject matter of example 1, where the first number of buffer entries corresponds to a first share of the processing pipeline to be allocated to the first one of the plurality of hosts and the second number of buffer entries corresponding to a second share of the processing pipeline to be allocated to the second one of the plurality of hosts.

Example 3 includes the subject matter of example 2, where the first share and the second share are unequal shares, and the first number of buffer entries and the second number of buffer entries are unequal.

Example 4 includes the subject matter of example 2, where less than all of the buffer entries are allocated to the plurality of hosts.

Example 5 includes the subject matter of any one of examples 2-4, where the first share is based on a first service level agreement (SLA) associated with the first host, and the second share is based on a second SLA associated with the second host.

Example 6 includes the subject matter of any one of examples 1-5, where the buffer management circuitry is to send an indication to the arbiter that the first entries are full to cause the arbiter to back pressure traffic of the first host.

Example 7 includes the subject matter of example 6, where the buffer management circuitry is to identify a vacancy in the first entries and send another indication to the arbiter to remove the back pressure of the traffic of the first host based on the vacancy in the first entries.

Example 8 includes the subject matter of any one of examples 6-7, where the buffer management circuitry includes arbiter logic to receive an indication that a subset of entries in a second shared buffer are full, where the subset of entries in the second shared buffer are associated with the first one of the plurality of hosts and another stage in the processing pipeline, and the arbiter logic is to prevent traffic of the first one of the plurality of hosts from progressing in the processing pipeline to the other stage.

Example 9 includes the subject matter of example 8, where another buffer is associated with the other stage and respective entries in the other buffer are allocated for the first one of the plurality of hosts and the second one of the plurality of hosts.

Example 10 includes the subject matter of any one of examples 6-9, where the back pressure is to prevent head of line blocking by the first one of the plurality of hosts.

Example 11 includes the subject matter of any one of examples 1-10, where hosts in the plurality of hosts are to perform a memory transaction in association with the first packet processing stage.

Example 12 includes the subject matter of any one of examples 1-11, where the processing pipeline is to prepare a packet to be sent on a network.

Example 13 includes the subject matter of example 12, where the first circuitry and the second circuitry are to be shared between the plurality of hosts to handle packets from the plurality of hosts.

Example 14 includes the subject matter of any one of examples 1-13, where the first circuitry or the second circuitry implements at least a portion of a remote direct memory access (RDMA) engine.

Example 15 includes the subject matter of any one of examples 1-14, further including the shared buffer.

Example 16 is a method including: configuring one or more shared buffers of a network interface device, where the network interface device is coupled to a plurality of host devices, the one or more shared buffers correspond to one or more stages in a shared packet processing pipeline implemented by the network interface device, and host devices in the plurality of host devices are to be allocated respective shares of the shared packet processing pipeline, where configuring the one or more shared buffers includes allocating entries in the one or more shared buffers to the plurality of host devices based on the respective shares of the shared packet processing pipeline; buffering data associated with traffic of a first one of the plurality of host devices in a first subset of entries in a first one of the one or more shared buffers, where the traffic is to be processed using the shared packet processing pipeline, the traffic is to proceed from a first stage in the shared packet processing pipeline to a second stage in the shared packet processing pipeline, and the data is associated with processing of the traffic by the second stage; and preventing forward progress of the traffic from the first stage to the second stage when the first subset of entries are occupied.

Example 17 includes the subject matter of example 16, where two or more of the respective shares of the shared packet processing pipeline are unequal shares.

Example 18 includes the subject matter of any one of examples 16-17, where less than all of the buffer entries are allocated to the plurality of hosts.

Example 19 includes the subject matter of any one of examples 16-18, where the respective shares of the shared packet processing pipeline are based on respective SLAs associated with the plurality of hosts.

Example 20 includes the subject matter of any one of examples 16-19, forward progress of the traffic is prevented to prevent head of line blocking by the first host.

Example 21 includes the subject matter of any one of examples 16-20, where hosts in the plurality of hosts are to perform a memory transaction in association with one or more of the processing stages.

Example 22 includes the subject matter of any one of examples 16-21, where the processing pipeline is to prepare packets of the plurality of hosts to be sent on a network.

Example 23 includes the subject matter of any one of examples 16-22, where at least one of the stages includes at least a portion of remote direct memory access (RDMA) transaction.

Example 24 is a system including means to perform the method of any one of examples 16-23.

Example 25 includes the subject matter of example 24, where the means perform a machine readable storage medium with instructions stored thereon, the instructions executable to cause a machine to perform the method of any one of examples 16-23.

Example 26 is a system including: a plurality of host devices; a network interface device including: an interface to couple to the plurality of hosts; first circuitry to perform an action in a first packet processing stage of a processing pipeline; second circuitry to perform an action in a second packet processing stage of the processing pipeline, where the second packet processing stage is to follow the first packet processing stage, and the plurality of hosts are to share the first circuitry and the second circuitry; buffer management circuitry to configure a shared buffer, where the shared buffer is to be shared between the plurality of hosts to assign a first subset of buffer entries in the shared buffer to hold data associated with a first one of the plurality of hosts and the second packet processing stage and a second subset of buffer entries to hold data associated with a second one of the plurality of hosts and the second packet processing stage; and arbiter circuitry to: determine whether to allow traffic of the first one of the plurality of hosts to progress from the first packet processing stage to the second packet processing stage based on the first subset of buffer entries in the shared buffer; and determine whether to allow traffic of the second one of the plurality of hosts to progress from the first packet processing stage to the second packet processing stage based on the second subset of buffer entries in the shared buffer.

Example 27 includes the subject matter of example 26, where the network interface device includes one of a smart network interface controller (NIC) or an infrastructure processing unit (IPU).

Example 28 includes the subject matter of any one of examples 26-27, where the arbiter circuitry is further to determine next traffic of one of the plurality of hosts to introduce to the processing pipeline based on the shared buffer.

Example 29 includes the subject matter of any one of examples 26-28, where the arbiter circuitry is to prevent head of link blocking among the plurality of hosts in the processing pipeline.

Example 30 includes the subject matter of any one of examples 26-29, where the network interface device further includes a network interface to facilitate a network connection between the plurality of hosts and a network.

Example 31 includes the subject matter of example 30, where the processing pipeline is to prepare packets of the plurality of hosts to be sent on the network.

Example 32 includes the subject matter of any one of examples 26-31, where two or more of the respective shares of the shared packet processing pipeline are unequal shares.

Example 33 includes the subject matter of any one of examples 26-32, where less than all of the buffer entries are allocated to the plurality of hosts.

Example 34 includes the subject matter of any one of examples 26-33, where the respective shares of the shared packet processing pipeline are based on respective SLAs associated with the plurality of hosts.

Example 35 includes the subject matter of any one of examples 26-34, where forward progress from the first packet processing stage to the second packet processing stage is to be prevented to prevent head of line blocking.

Example 36 includes the subject matter of any one of examples 26-35, where hosts in the plurality of hosts are to perform a memory transaction in association with one or more of the processing stages.

Example 37 includes the subject matter of any one of examples 26-36, where at least one of the stages includes at least a portion of remote direct memory access (RDMA) transaction.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
an interface to couple to a plurality of hosts;
first circuitry to perform an action in a first packet processing stage of a processing pipeline;
second circuitry to perform an action in a second packet processing stage of the processing pipeline, wherein the second packet processing stage is to follow the first packet processing stage, and the plurality of hosts are to share the first circuitry and the second circuitry;
buffer management circuitry to configure a shared buffer, wherein the shared buffer is to be shared between the plurality of hosts to assign a first number of buffer entries in the shared buffer to hold data associated with a first one of the plurality of hosts and the second packet processing stage and a second number of buffer entries to hold data associated with a second one of the plurality of hosts and the second packet processing stage; and
an arbiter to select traffic of one of the first one of the plurality of hosts or the second one of the plurality of hosts to be processed in the second packet processing stage based on the shared buffer.

2. The apparatus of claim 1, wherein the first number of buffer entries corresponds to a first share of the processing pipeline to be allocated to the first one of the plurality of hosts and the second number of buffer entries corresponding to a second share of the processing pipeline to be allocated to the second one of the plurality of hosts.

3. The apparatus of claim 2, wherein the first share and the second share are unequal shares, and the first number of buffer entries and the second number of buffer entries are unequal.

4. The apparatus of claim 2, wherein less than all of the buffer entries are allocated to the plurality of hosts.

5. The apparatus of claim 2, wherein the first share is based on a first service level agreement (SLA) associated with the first host, and the second share is based on a second SLA associated with the second host.

6. The apparatus of claim 1, wherein the buffer management circuitry is to send an indication to the arbiter that the first entries are full to cause the arbiter to back pressure traffic of the first host.

7. The apparatus of claim 6, wherein the buffer management circuitry is to identify a vacancy in the first entries and send another indication to the arbiter to remove the back pressure of the traffic of the first host based on the vacancy in the first entries.

8. The apparatus of claim 6, wherein the buffer management circuitry comprises arbiter logic to receive an indication that a subset of entries in a second shared buffer are full, wherein the subset of entries in the second shared buffer are associated with the first one of the plurality of hosts and another stage in the processing pipeline, and the arbiter logic is to prevent traffic of the first one of the plurality of hosts from progressing in the processing pipeline to the other stage.

9. The apparatus of claim 8, wherein another buffer is associated with the other stage and respective entries in the other buffer are allocated for the first one of the plurality of hosts and the second one of the plurality of hosts.

10. The apparatus of claim 6, wherein the back pressure is to prevent head of line blocking by the first one of the plurality of hosts.

11. The apparatus of claim 1, wherein hosts in the plurality of hosts are to perform a memory transaction in association with the first packet processing stage.

12. The apparatus of claim 1, wherein the processing pipeline is to prepare a packet to be sent on a network.

13. The apparatus of claim 12, wherein the first circuitry and the second circuitry are to be shared between the plurality of hosts to handle packets from the plurality of hosts.

14. The apparatus of claim 1, wherein the first circuitry or the second circuitry implements at least a portion of a remote direct memory access (RDMA) engine.

15. The apparatus of claim 1, further comprising the shared buffer.

16. A method comprising:
configuring one or more shared buffers of a network interface device, wherein the network interface device is coupled to a plurality of host devices, the one or more shared buffers correspond to one or more stages in a shared packet processing pipeline implemented by the network interface device, and host devices in the plurality of host devices are to be allocated respective shares of the shared packet processing pipeline, wherein configuring the one or more shared buffers comprises allocating entries in the one or more shared buffers to the plurality of host devices based on the respective shares of the shared packet processing pipeline;
buffering data associated with traffic of a first one of the plurality of host devices in a first subset of entries in a first one of the one or more shared buffers, wherein the traffic is to be processed using the shared packet processing pipeline, the traffic is to proceed from a first stage in the shared packet processing pipeline to a second stage in the shared packet processing pipeline, and the data is associated with processing of the traffic by the second stage; and
preventing forward progress of the traffic from the first stage to the second stage when the first subset of entries are occupied.

17. A system comprising:
one or more host devices; and
a network interface device comprising:
an interface to couple to a plurality of hosts including the one or more host devices;
first circuitry to perform an action in a first packet processing stage of a processing pipeline;
second circuitry to perform an action in a second packet processing stage of the processing pipeline, wherein the second packet processing stage is to follow the first packet processing stage, and the plurality of hosts are to share the first circuitry and the second circuitry;
buffer management circuitry to configure a shared buffer, wherein the shared buffer is to be shared between the plurality of hosts to assign a first subset of buffer entries in the shared buffer to hold data associated with a first one of the plurality of hosts and the second packet processing stage and a second subset of buffer entries to hold data associated with a second one of the plurality of hosts and the second packet processing stage; and
arbiter circuitry to:
determine whether to allow traffic of the first one of the plurality of hosts to progress from the first packet processing stage to the second packet processing stage based on the first subset of buffer entries in the shared buffer; and
determine whether to allow traffic of the second one of the plurality of hosts to progress from the first packet processing stage to the second packet processing stage based on the second subset of buffer entries in the shared buffer.

18. The system of claim 17, wherein the network interface device comprises one of a smart network interface controller (NIC) or an infrastructure processing unit (IPU).

19. The system of claim 17, wherein the arbiter circuitry is further to determine next traffic of one of the plurality of hosts to introduce to the processing pipeline based on the shared buffer.

20. The system of claim 17, wherein the arbiter circuitry is to prevent head of link blocking among the plurality of hosts in the processing pipeline.
